(19) United States
(12) Patent Application Publication
(10) Pub. No.: US 2007/0093110 A1
(43) Pub. Date: Apr. 26, 2007

(54) Connector and display device having the same

(75) Inventors: Jin Ho Park, Suwon-si (KR); Kyung Soo Kim, Suwon-si (KR)

Correspondence Address: DLA PIPER RUDNICK GRAY CARY US, LLP, 2000 UNIVERSITY AVENUE, E. PALO ALTO, CA, 94303-2248, US

(73) Assignee: Samsung Electronics Co., Ltd.

(21) Appl. No.: 11/399,870

(22) Filed: Apr. 7, 2006

(30) Foreign Application Priority Data
Oct. 25, 2005 (KR) 10-2005-0100488

(51) Int. Cl. H01R 13/627

(52) U.S. Cl. 439/351

(57) ABSTRACT

A connector preventing disengagement from a circuit board and a display device is presented. The connector includes a securing portion fixed to a surface of the circuit board and at least one protrusion extending from the securing portion. The connector is inserted into at least one through-hole in the circuit board.

### CROSS-REFERENCE TO RELATED APPLICATION

This patent application claims priority from Korean Patent Application No. 10-2005-0100488 filed on Oct. 25, 2005, and all of the benefits accruing therefrom under 35 U.S.C. 119, the content of which in its entirety is herein incorporated by reference.

### BACKGROUND OF THE INVENTION

1. Field of the Invention

The present invention relates to a connector and a display device having the same, and more particularly, to a connector capable of preventing disengagement from a printed circuit board, and a display device having the same.

2. Description of the Related Art

A liquid crystal display (“LCD”) device controls light transmittance through a liquid crystal layer by applying an electric field, thereby displaying images. The liquid crystals in the liquid crystal layer have dielectric anisotropy. The liquid crystal layer is typically part of an LCD panel in which liquid crystal cells are arranged in a matrix. A driving circuit drives the LCD panel based on received image data signals.

The array of liquid crystal cells in the LCD panel displays images by controlling the light transmittance in response to a pixel signal.

The driving circuit includes a gate driver for driving gate lines of the LCD panel, a data driver for driving data lines of the LCD panel, a timing controller for controlling the driving timing of the gate and data drivers, and a power supply for supplying power signals to the LCD panel and the drivers.

The driving circuit is mounted on a printed circuit board (“PCB”) and connected via a connector to an external system generating a power signal, a pixel voltage signal, a clock signal, etc.

The connector is connected to the PCB by a soldering process. The connector is subjected to an aging test for detecting a defect by driving the LCD device under conditions of high temperature and high humidity. During a mounting process performed after the aging test, operations of connecting and disconnecting the connector are repeatedly implemented. At this time, due to the large amount of force that is applied during the repeated connecting and disconnecting process, the connector sometimes becomes separated from the PCB. FIG. 1 illustrates a connector 10 having a fixing terminal 16. The fixing terminal 16 is attached to the PCB 2. Upon separation of the connector 10 and the PCB 2, the connector 10 becomes unfastened. Although the connector 10 can endure a downward pressure applied from the top, it cannot endure the same amount of pressure applied upward from the bottom, for example in the direction shown by the arrows. Thus, if the force is applied from the bottom of the connector 10, the connector 10 is detached and loosened from the PCB 2.

### SUMMARY OF THE INVENTION

The invention provides a connector that is less likely to disengage from a PCB than a conventional connector, and a displaying device made with the connector.

According to an exemplary embodiment of the present invention, there is provided a connector connected to a circuit board, wherein the connector includes a securing portion designed to be fixed to an upper surface of the circuit board. At least one protrusion extends from the securing portion and is configured to be inserted into at least one through hole in the circuit board.

The protrusion is preferably fixed to the circuit board through a solder formed on a side wall of the through hole.

The securing portion is fixed to the circuit board through a solder formed on at least one region of an upper surface of the circuit board.

The connector may include a body coupled to the securing portion and a connection terminal coupled to the body.

The connector may be a female or male connector.

According to another exemplary embodiment of the present invention, there is provided a display device including a display panel for forming a video image, a driving circuit for driving the display panel, a circuit board, and a connector. The circuit board has a plurality of signal generators for generating driving signals that are supplied to the driving circuit and at least one through-hole formed in the circuit board. The connector has at least one protrusion inserted into the through-hole.

The connector may also include a securing portion extending from the protrusion and fixed to an upper surface of the circuit board, a body coupled to the securing portion, and a connection terminal coupled to the body and connected to the driving circuit.

The protrusion is fixed to the circuit board through a solder formed on a side wall of the through hole.

The securing portion may be fixed to the circuit board through a solder formed on at least one region of an upper surface of the circuit board.

The circuit board may be a data printed circuit board on which the signal generators are mounted. Alternatively, the circuit board may be a control printed circuit board on which the signal generators are mounted.

The display device may also include a data printed circuit board formed between the control printed circuit board and the driving circuit, for supplying the driving signal generated from the signal generators to the driving circuit.

### BRIEF DESCRIPTION OF THE DRAWINGS

The above and other features of the present invention will become more apparent to persons skilled in the art from the following detailed description of exemplary embodiments shown in the accompanying drawings, in which:

FIG. 1 is a cross-sectional view of a conventional connector connected to a PCB;

FIG. 2 is a perspective view of a connector for use in an LCD device according to an embodiment of the present invention;

FIG. 3 is a cross-sectional view of the connector of FIG. 2 connected to a PCB;

FIGS. 4A, 4B and 4C are enlarged cross-sectional views illustrating an engaging region of the connector and PCB illustrated in FIG. 3;

FIG. 5 is a perspective view of a female connector for use in an LCD device according to an embodiment of the present invention;

FIGS. 6A and 6B are perspective views for explaining an engaging process of the connector of the exemplary embodiment of the present invention and a connector coupled to a cable;

FIG. 7 is a graphical view illustrating an LCD device having the connector according to exemplary embodiments of the present invention;

FIG. 8 is a plane view of an LCD panel connected through a data tape carrier package to a data PCB illustrated in FIG. 7; and

FIG. 9 is a graphical view illustrating an LCD device having the connector according to exemplary embodiments of the present invention.

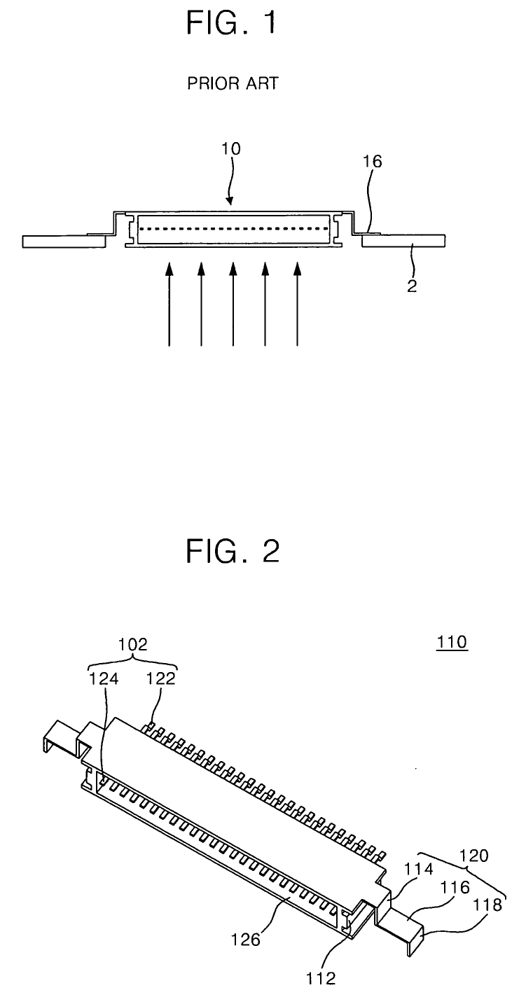

### DETAILED DESCRIPTION OF THE EMBODIMENTS

FIG. 2 is a perspective view of a connector according to an exemplary embodiment of the present invention.

Referring to FIG. 2, a male connector 110 has a body 112 providing a connection space 126, a plurality of connection terminals 102 formed within the connection space 126, and a supporter 120 for fixing the connector 110 to a printed circuit board (PCB) (not shown).

The body 112 comprises an upper surface, a lower surface, and a side surface formed between the upper and lower surfaces, providing the connection space 126. A body of a female connector (not shown) connected to a cable is inserted into the connection space 126 of the body 112.

Each of the connection terminals 102 has an input terminal 124 and an output terminal 122 connected to the input terminal 124.

The input terminal 124 is connected to a connection terminal of the female connector connected to the cable. The output terminal 122 is connected to a signal line formed on the PCB.

The supporter 120 comprises an extender 114 extending from the body 112, a securing portion 116 to be mounted on the PCB, and a protrusion 118 that is designed to be inserted into a through-hole in the PCB. Part of the extender 114 extends in a first direction substantially parallel to the upper surface of the body 112 and other part of the extender 114 extends in a second direction. The protrusion 118 also extends in the second direction substantially perpendicular to the upper surface of the body 112. The securing portion 116 extends in the first direction.

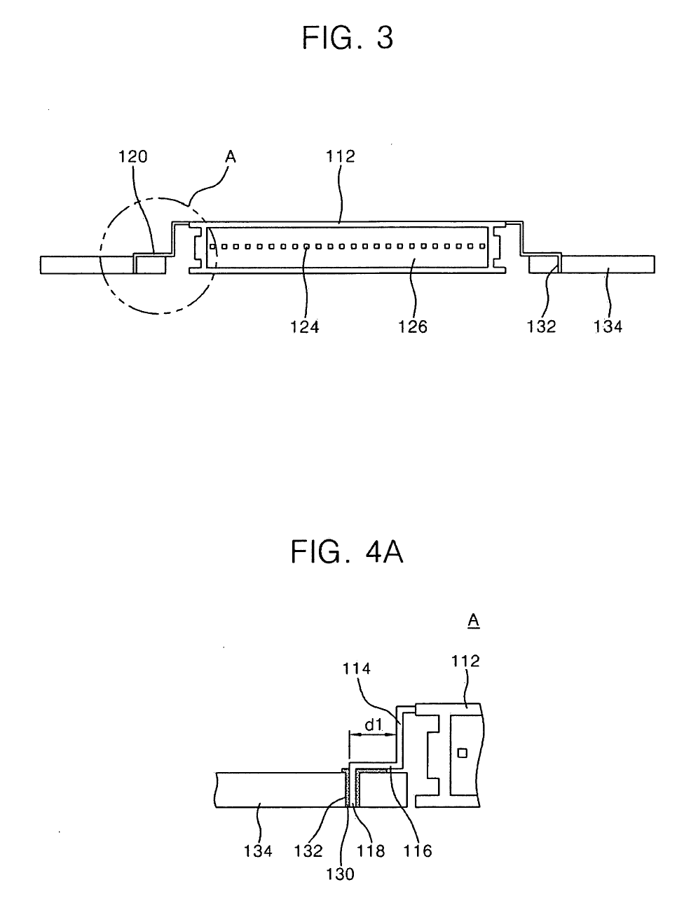

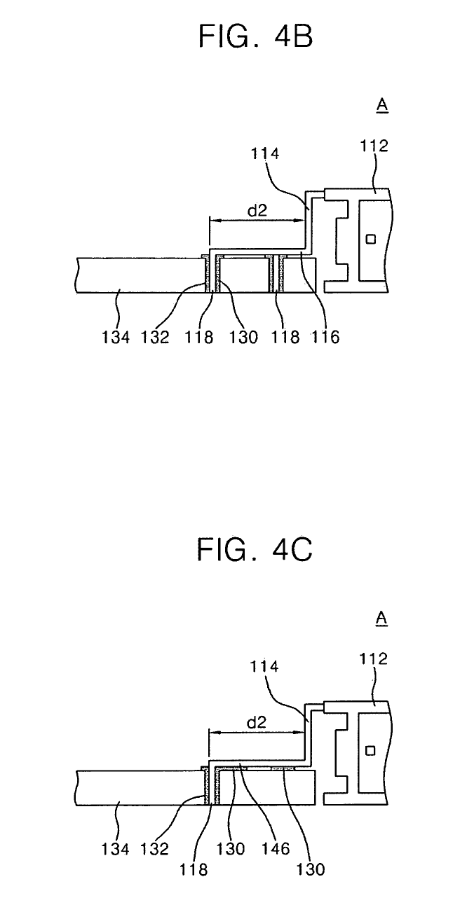

FIG. 3 is a cross-sectional view of the connector of FIG. 2 connected to a PCB; and FIGS. 4A, 4B and 4C are enlarged cross-sectional views illustrating an engaging region A of the connector and PCB illustrated in FIG. 3 and;

As illustrated in FIGS. 3, 4A, 4B and 4C, the protrusion 118 is inserted into a through-hole 132 extending through a PCB 134. The protrusion 118 is fixed by a solder 130 formed at a side wall of the through-hole 132 as illustrated in FIG. 4A. Further, as shown in FIG. 4B, there may be multiple protrusions 118 designed to be inserted into multiple through-holes 132 in order to enhance the fixing force of the male connector 110. Although FIG. 4B shows two protrusions 118 and two through-holes 132, it should be noted that this is just an exemplary embodiment and not a limitation of the invention.

The securing portion 116 is fixed by the solder 130 formed at the upper surface of the PCB 134. The securing portion 116 has a part connected to one solder 130 as shown in FIG. 4A. As shown in FIG. 4C, the securing portion 116 is assembled with the PCB 134 by at least two solders 130 so that the contact area with the solder 130 is increased compared to the securing portion 116 of FIG. 4A. As a result, the fixing force of the connector 110 may be strengthened. “Fixing force,” as used herein, indicates how securely the connector 110 couples two parts, i.e. the securing potion 116 and the PCB 134.

Alternatively, the solder 130 also can be formed at the rear surface of the PCB 134. The male connector 110 can be fixed to the PCB 134 by the solder 130 formed at the side and upper surfaces of the PCB 134.

As described above, the male connector 110 according to an exemplary embodiment of the present invention supports the pressure applied thereon by being fixed to the PCB 134 by the protrusion 118. Accordingly, even if any force is applied to either the upper or lower side of the male connector 110, the fixing force of the male connector 110 may be increased compared to that of the conventional connector.

Table 1 as will be below described represents comparison results of conventional connector and the connector 110 of the present invention. Referring to Table 1, the conventional male connector is detached from the PCB by a force of 12 to 13 KgF, whereas the male connector 110 of the present invention is detached from the PCB 134 by a force of 17 to 18 KgF.

TABLE 1

| | |
|---|---|
| Conventional Connector | Present Invention |

| | Left | Right | Left | Right |
|---|---|---|---|---|
| | supporter | supporter | supporter | supporter |
| Test 1 | 12.50 KgF | 12.00 KgF | 17.10 KgF | 17.80 KgF |
| Test 2 | 12.60 KgF | 12.80 KgF | 18.10 KgF | 18.20 KgF |
| Test 3 | 13.00 KgF | 12.90 KgF | 17.50 KgF | 17.60 KgF |
| Test 4 | 12.50 KgF | 12.50 KgF | 17.20 KgF | 17.60 KgF |
| Test 5 | 12.60 KgF | 12.80 KgF | 18.10 KgF | 17.70 KgF |
| Average | 12.54 KgF | 12.60 KgF | 17.60 KgF | 17.78 KgF |

It can be understood from Table 1 that the male connector 110 decreases the likelihood of its supporter detached from the PCB 134 in comparison to the conventional connector.

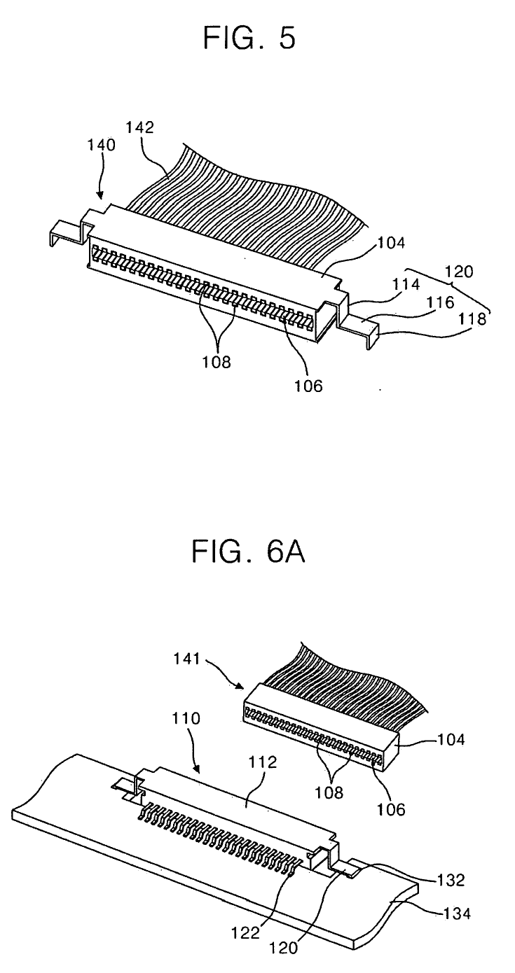

FIG. 5 is a perspective view of a female connector for use in the LCD device according to an exemplary embodiment of the present invention.

Referring to FIG. 5, a female connector 140 has a body 104 providing a connection space 106, a plurality of connection terminals 108 formed at the upper and lower surfaces of the body 104, and a supporter 120 fixing the female connector 140 to a PCB.

The body 104 includes an upper surface, a lower surface, and a side surface formed between the upper and lower surfaces, providing the connection space 106. Input terminals of a male connector 110 of FIG. 2 are inserted into the connection space 106 of the body 104.

The connection terminals 108 face each other with respect to the body 104 exposed by the connection space 106. The connection terminals 108 are in contact with the upper and lower surfaces of the input terminals of the male connector 110 and are connected to a cable 142.

The supporter 120 includes an extender 114 extending from the body 104, a securing portion 116 mounted on the PCB, and a protrusion 118 configured to be inserted into a through-hole extending through the PCB.

The protrusion 118 is fixed by a solder formed at the side surface of the PCB exposed by the through-hole.

The securing portion 116 is fixed by a solder formed at the upper surface of the PCB.

The female connector 140 supports pressure applied thereon by being fixed to the PCB by the protrusion 118. Regardless of whether the force is applied to the upper or lower side of the female connector 140, the fixing force of the female connector 140 becomes increased. Thus, the likelihood of a defect that causes the connector to become unfastened, resulting in a detachment of the female connector 140 from the PCB 134, is decreased or even eliminated.

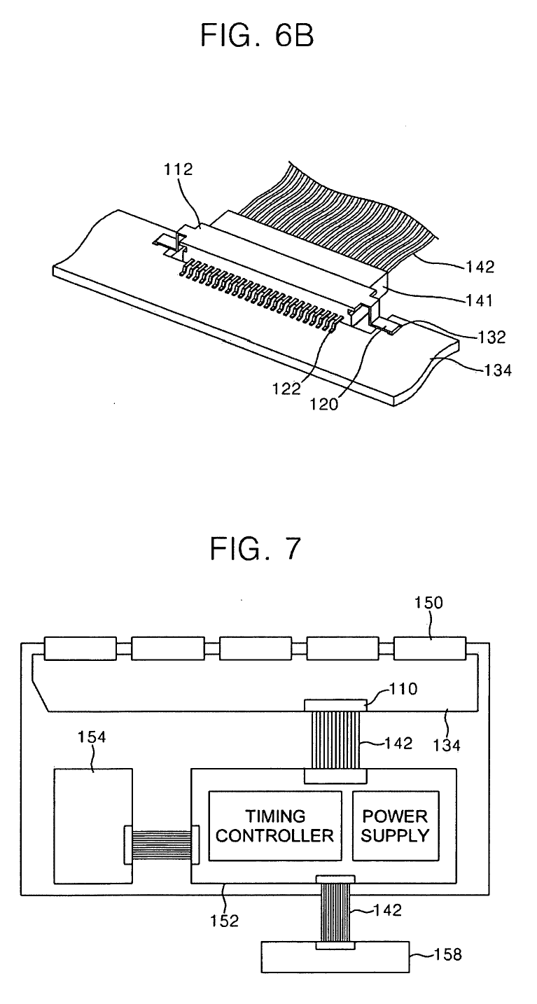

FIGS. 6A and 6B are perspective views for explaining an engaging process of the connector of the exemplary embodiment of the present invention and a connector coupled to a cable. In FIGS. 6A and 6B, there are shown a male connector as the connector of the exemplary embodiment of the present invention and a female connector as the connector coupled to the cable, for example.

As illustrated in FIG. 6A, the male connector 110 is fixed to the PCB 134 and a female connector 141 is inserted into the connection space of the male connector 110. The female connector 141 has the body 104 providing the connection space 106 into which the input terminals 124 (shown in FIG. 2) of the male connector 110 are inserted, and the connection terminals 108 which are formed to correspond to the input terminals 124 of the male connector 110 and connected to the upper and lower surfaces of the input terminals 124. The male connector 110 has the same construction as that shown in FIGS. 2, 4A, 4B and 4C and therefore a detailed description thereof will be omitted.

The female connector 140 is inserted into the male connector 110 as shown in FIG. 6B and thus the connection terminals of the female connector 140 are connected to the input terminals 124 of the male connector 110. Therefore, driving signals applied to the cable 142 connected to the female connector 140 are transmitted to signal lines of the PCB 134 connected to the output terminals 122 of the male connector 110.

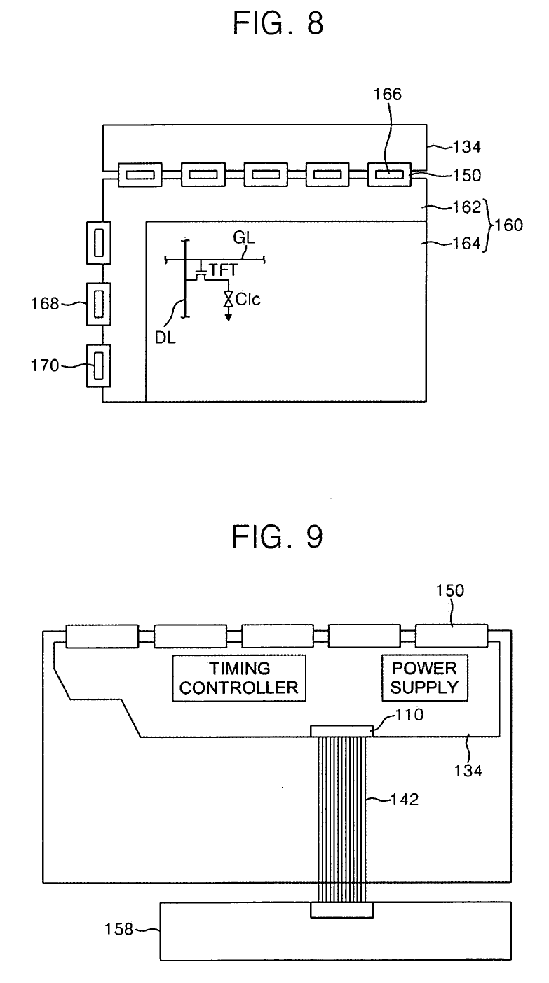

FIG. 7 is a graphical view illustrating an LCD device having the connector according to exemplary embodiments of the present invention and FIG. 8 is a plane view of an LCD panel connected through a data tape carrier package to a data PCB illustrated in FIG. 7.

Referring to FIGS. 7 and 8, the LCD device includes an LCD panel 160, a data PCB 134, and a control PCB 152 connected to the data PCB 134.

The LCD panel 160 includes a thin film transistor (TFT) substrate 162 and a color filter (CF) substrate 164 with a liquid crystal disposed therebetween.

The TFT substrate 162 is electrically connected to the data PCB 134 through a tape carrier package (“TCP”) 150 in which a data integrated circuit (“IC”) 166 is mounted. The data IC 166 converts pixel data into an analog pixel signal and transmits the converted signal to the LCD panel 160.

The TFT substrate 162 is also electrically connected to a gate TCP 168 on which a gate IC 170 is mounted. Alternatively, the gate IC 170 may be formed on the TFT substrate with a TFT process. Further, although the gate TCP 168 is described herein, the gate IC 170 may be mounted on a flexible printed circuit (FPC). The gate IC 170 sequentially applies a scan signal of a high gate voltage to the gate lines GL. The gate IC 170 applies a scan signal of a turn off gate voltage to the gate lines GL during a period when no turn on gate voltage is supplied. The data PCB 134 is connected to the data TCP 150 and to the control PCB 152 through a connector 110 and a cable 142. The data PCB 134 applies a control signal, a power signal, pixel data, etc. to the data and gate ICs 166 and 170. These signals are received from a timing controller, a power supply, etc. mounted on the control PCB 152.

The control PCB 152 applies a backlight power signal generated from the power supply to a backlight inverter 154. The control PCB 152 is connected to the data PCB 134 through the cable 142 and the connector 110. Therefore, the control PCB 152 applies the control signal, power signal, pixel data, etc. to the data PCB 134. These signals are received from the timing controller, power supply, etc. mounted on the control PCB 152. An input power signal, pixel data, a clock signal, a synchronization signal, etc. transmitted from a user connector 158 connected through the cable 142 are supplied to the timing controller, power supply, etc. mounted on the control PCB 152.

FIG. 9 is a graphical view illustrating an LCD device having the connector according to exemplary embodiments of the present invention.

The LCD device has the same elements as the LCD device of FIG. 7 except that the user connector is connected to the data PCB without passing through the control PCB. Therefore, a detailed description thereof will be omitted.

The data PCB 134 supplies the backlight power signal generated from the power supply to a backlight inverter (not shown). The data PCB 134 is connected to the data TCP 150 and simultaneously to the user connector 158 through the connector 110 and the cable 142. The input power signal, pixel data, clock signal, synchronization signal, etc. transmitted by the user connector 158 are supplied to the timing controller, power supply, etc., mounted on the data PCB 134 through the cable 142. The control signal, power signal, pixel data, etc. generated from the timing controller, power supply, etc. are applied to the data and gate ICs 166 and 170.

The connector of the present invention is applied not only to the LCD device but also to a display device such as a plasma display panel and an electric field emitting device. Moreover, the connector is applicable to all the devices having the connector.

According to the connector and the display device having the connector, a protrusion of the connector is inserted into a through-hole of a PCB. Therefore, even if force is applied from any one of the upper and lower sides of the connector, the supporting force of the connector becomes increased, thereby preventing the connector from becoming separated from the PCB.

While the invention has been shown and described with reference to a certain preferred embodiment thereof, it will be understood by those skilled in the art that various changes in form and details may be made therein without departing from the spirit and scope of the invention as defined by the appended claims.

1. A connector for connecting to a circuit board, the connector comprising:
a top surface and a bottom surface that create a connection space between them;
a securing portion extending from the top surface and fixed to a surface of the circuit board; and
at least one protrusion extending from the securing portion, wherein the at least one protrusion is inserted into at least one through-hole formed in the circuit board.

2. The connector of claim 1, wherein the protrusion is fixed to the circuit board through a solder formed on a side wall of the through hole.

3. The connector of claim 1, wherein the securing portion is fixed to the circuit board through a solder formed on at least one region of a surface of the circuit board.

4. The connector of claim 1 further comprising:
a connection terminal located in the connection space.

5. The connector of claim 1, wherein the connector is a female connector.

6. The connector of claim 1, wherein the connector is a male connector.

7. A display device comprising:
a display panel displaying a video image;
a driving circuit driving the display panel;
a circuit board including:
a plurality of signal generators generating driving signals that are supplied to the driving circuit; and
at least one through-hole formed in the circuit board; and
a connector that has a top surface and a bottom surface that form a connection space, the connector comprising at least one protrusion that extends from the top surface to be inserted into the through-hole.

8. The display device of claim 7, wherein the connector further comprises:
a securing portion extending from the protrusion and fixed to a surface of the circuit board;
and
a connection terminal located in the connection space and connected to the driving circuit.

9. The display device of claim 7, wherein the protrusion is fixed to the circuit board through a solder formed on a side wall of the through hole.

10. The display device of claim 8, wherein the securing portion is fixed to the circuit board through a solder formed on at least one region of a surface of the circuit board.

11. The display device of claim 7, wherein the circuit board is a data printed circuit board on which the signal generators are mounted.

12. The display device of claim 7, wherein the circuit board is a control printed circuit board on which the signal generators are mounted.

13. The display device of claim 12, further comprising a data printed circuit board formed between the control printed circuit board and the driving circuit, for supplying the driving signal generated from the signal generators to the driving circuit.
